(19) United States
(12) Patent Application Publication
(10) Pub. No.: US 2016/0283876 A1
(43) Pub. Date: Sep. 29, 2016

(54) SYSTEM AND METHOD FOR PROVIDING AUTOMOMOUS CONTEXTUAL INFORMATION LIFE CYCLE MANAGEMENT

(71) Applicant: Tata Consultancy Services Limited, Mumbai (IN)

(72) Inventors: Satyanarayanan RAMASWAMY, Santa Clara, CA (US); Rajeev Mullakkara Azhuvath, Kochi (IN); Ashok Krish, Chennai (IN); Paul Karan Datta, Chennai (IN)

(73) Assignee: Tata Consultancy Services Limited, Mumbai (IN)

(21) Appl. No.: 15/061,888

(22) Filed: Mar. 4, 2016

(30) Foreign Application Priority Data
Mar. 24, 2015 (IN) 978/MUM/2015

(51) Int. Cl. G06Q 10/06; G06F 17/27; G06F 17/30

(52) U.S. Cl. CPC G06Q 10/0637; G06F 17/30719; G06F 17/30554; G06F 17/30707; G06F 17/2705; G06F 17/277

(57) ABSTRACT

This disclosure relates generally to information life cycle management, and more particularly to system and method for providing autonomous contextual information life cycle management. In order to visualize the data, initially, textual interaction may be captured from a social-networking platform. Upon capturing, business entities may be identified from the textual interaction. Subsequently, a system entity corresponding to each business entity may be identified. Subsequently, a key-value pair having a pre-defined condition corresponding to each system entity may be generated. Further a query may be generated based on the key-value pair. Upon generating the query, a context may be derived associated to the textual interaction. Based on the context and the query, data may be extracted from a data repository. Subsequent to the extraction of the data, the data may be visualized in a graphical form using one or more predefined visualization templates.

### PRIORITY CLAIM

This U.S. patent application claims priority under 35 U.S.C. §119 to: India Application No. 978/MUM/2015, filed on 24 Mar. 2015. The entire contents of the aforementioned application are incorporated herein by reference.

### TECHNICAL FIELD

This disclosure relates generally to information life cycle management, and more particularly to a system and a method for providing autonomous contextual information life cycle management.

### BACKGROUND

The inventors here have recognized several technical problems with such conventional systems, as explained below. With volatile market dynamics and explosion of enterprise data, a digitally reimagined enterprise may determine the success of a firm. The ‘digital strategy’ adopted by an enterprise, based on its digitized business/people/process management and performance evaluation from time to time enable the enterprise to capture new business opportunities, sustain the competition and outperform others. The success of the enterprise thus depends on devising the digital strategy correctly at the right time. It has been observed that the enterprise relies on the data generated from the day-to-day affairs within the enterprise to identify the pitfalls in the business model, and thereby devise solutions to overcome such pitfalls. Most of the performance evaluation is done manually by comparing the various parameters, such as revenues, profits, investments and the like; defining the performance of the enterprise. While evaluating the performance, the enterprise considers the data available within the enterprise in the form of databases, existing in silos for example, enterprise data, competitor data, employee data and the like; however, it is extremely difficult to perform analytics by inter-relating such data only by manual expertise. It has been further observed that the data obtained from interactions between stakeholders' or opinions of the stakeholders regarding multiple business scenarios may influence the strategy adopted by the enterprise to a major extent. This is because the stakeholders are closely associated with the business dealings associated to the enterprise and their opinions may directly or indirectly impact the performance of the enterprise. However, such interactions data is highly disaggregated, and it is extremely difficult for the existing system to segregate and correlate meaningful information within these interactions, and utilize it further to devise relevant strategies for effective decision-making for the enterprise.

### SUMMARY

Embodiments of the present disclosure present technological improvements as solutions to one or more of the above-mentioned technical problems recognized by the inventors in conventional systems. For example, in one embodiment, a system for visualizing data in a graphical form based on information exchanged between pluralities of users on a social-networking platform is disclosed. In one aspect, the system may comprise a processor and a memory coupled to the processor. The processor may execute a plurality of modules present in the memory. The plurality of modules may comprise a Natural Language Processing (NLP) engine module, an analytics engine module, a visualization engine module, a recommendation engine module, and a feedback module. The analytics engine module may further comprise a query generator, a context builder, and a data extractor. The NLP engine module may capture textual interaction amongst a plurality of users on a social-networking platform. The NLP engine module may further pre-process the textual interaction in order to identify one or more business entities associated with the textual interaction. In one aspect, each business entity may be identified corresponding to a category of a plurality of predefined categories. The NLP engine module may further identify a system entity corresponding to each business entity based on a pre-defined mapping of a plurality of business entities with a plurality of system entities stored in a data repository. The query generator may generate a key-value pair having a pre-defined condition corresponding to each system entity. In one aspect, a key and a value, in each key value pair, indicates the category of a system entity and the system entity respectively. Further the pre-defined condition represents a relation between the key and the value. The query generator may further generate a query based on the key-value pair corresponding to each system entity. The context builder may derive a context associated to the textual interaction based upon a predefined set of rules. The data extractor may extract data from the data repository based on the query and the context. The visualization engine module may visualize the data in a graphical form using one or more predefined visualization templates.

In another embodiment, a processor implemented method for visualizing data in a graphical form based on information exchanged between pluralities of users on a social-networking platform is disclosed. In order to visualize the data, initially, textual interaction amongst a plurality of users on the social-networking platform may be captured. Upon capturing the textual interaction, the textual interaction may be pre-processed in order to identify one or more business entities associated with the textual interaction. In one aspect, each business entity may be identified corresponding to a category of a plurality of predefined categories. Subsequent to the identification of the one or more business entities, a system entity corresponding to each business entity may be identified based on a pre-defined mapping of a plurality of business entities with a plurality of system entities stored in a data repository. Subsequently, a key-value pair having a pre-defined condition corresponding to each system entity may be generated. In one aspect, a key and a value, in each key value pair, indicates the category of a system entity and the system entity respectively. Further the pre-defined condition represents a relation between the key and the value. Further, a query may be generated based on the key-value pair corresponding to each system entity. Further, a context associated to the textual interaction may be derived based upon a predefined set of rules. Based on the query and the context, data may be extracted from the data repository. Subsequent to the extraction of the data, the data may be visualized in a graphical form using one or more predefined visualization templates. In one aspect, the aforementioned method for visualizing the data in the graphical form is performed by using a processor using programmed instructions stored in a memory.

In yet another embodiment, non-transitory computer readable medium embodying a program executable in a computing device for visualizing data in a graphical form based on information exchanged between pluralities of users on a social-networking platform is disclosed. The program may comprise a program code for capturing textual interaction amongst a plurality of users on a social-networking platform. The program may comprise a program code for pre-processing the textual interaction in order to identify one or more business entities associated with the textual interaction, wherein each business entity may be identified corresponding to a category of a plurality of predefined categories. The program may comprise a program code for identifying a system entity corresponding to each business entity based on a pre-defined mapping of a plurality of business entities with a plurality of system entities stored in a data repository. The program may comprise a program code for generating a key-value pair having a pre-defined condition corresponding to each system entity, wherein a key and a value, in each key value pair, indicates the category of a system entity and the system entity respectively, and wherein the pre-defined condition represents a relation between the key and the value. The program may comprise a program code for generating a query based on the key-value pair corresponding to each system entity. The program may comprise a program code for deriving a context associated to the textual interaction based upon a predefined set of rules. The program may comprise a program code for extracting data from the data repository based on the query and the context. The program may comprise a program code for visualizing the data in a graphical form using one or more predefined visualization templates.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a network implementation of a system for visualizing data in a graphical form based on information exchanged between pluralities of users on a social-networking platform, according to some embodiments of the present disclosure.

FIG. 2 illustrates the system, according to some embodiments of the present disclosure.

FIGS. 3 and 4 illustrate functional architecture of the implementation of the system, according to some embodiments of the present disclosure.

FIG. 5 illustrates process flow diagrams, according to some embodiments of the present disclosure.

FIG. 6 illustrates a method for visualizing the data in the graphical form to the user, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein. Further, the terms “user' and “stakeholder” have been used interchangeably throughout the detailed description, and refer to the users of the system who are influenced by/influence the decision-making/performance of an enterprise, such as employees, management, vendors, investors and the like.

The present disclosure describes a system and method for providing autonomous contextual information life cycle management. It may be understood that textual interaction between stakeholders on a social-networking platform may directly or indirectly provide significant information regarding the performance of an enterprise. This information may facilitate management of the enterprise to deduce meaningful information from the textual interaction and thereby devise strategies and solutions based on the meaningful information in order to significantly improve the performance of the enterprise. It may be understood that the textual interaction are contextual in nature, and sparsely disaggregated. The present invention thus attempts to integrate the textual interaction with other available data within the enterprise, to facilitate the management in retrieving the meaningful information by using Artificial Intelligence (AI) based on machine learning algorithms.

In order to retrieve the meaningful information, the textual interaction may be captured from the social-networking platform. Examples of the social-networking platform may include, but not limited to, a Blog, a forum, a Question and Answer platform, and an electronic mail. In one aspect, the textual interaction may indicate any interaction of the user with other users within the enterprise. For example, in case a user blogs on a social-networking platform that, “what is the increase in the revenues of ABC Textiles in the past quarter”. Here the quoted text may refer to as the textual interaction. The textual interaction, being in natural language format, is converted into machine understand format. The machine readable textual interaction may then be processed to identify business entities in the textual interaction. Therefore, after converting the textual interaction, one or more business entities associated with the textual interaction, may be identified in the textual interaction. Examples of the one or more business entities may include, but not limited to, product, brand, sales target, revenue, net profit, operational cost, financial year, quarter. In one aspect, the one or more business entities may refer to any real-world entity in the business domain of the enterprise.

Upon identifying the one or more entities, a system entity may be identified corresponding to each business entity, of the one or more business entities, based on a pre-defined mapping of a plurality of business entities with a plurality of system entities stored in a data repository. In one aspect, the system entity may further be identified based on at least one of data dictionary, NER dictionary, domain-entity dictionary, ontology, thesaurus, and POS mapping trained data.

For example, consider the textual interaction comprises “what is the increase in the revenues of ABC Textiles in the past quarter”. Based on the aforementioned textual interaction, ‘revenues’ is identified as a ‘business entity’. Since in most of the enterprises ‘revenues’ may be referred to as ‘sales income’ along with other terminologies such as ‘profit’, the data repository stores the pre-defined mapping of ‘sales income’ with ‘revenues’ and therefore ‘sales income’ is identified as the system entity corresponding to ‘revenues’. Similarly ‘past quarter’ is identified as the business entity and ‘month (sysdate-(sysdate-90))’ is identified as the system entity corresponding to ‘past quarter’.

Upon identifying the system entity, a key-value pair having a pre-defined condition corresponding to each system entity may be generated. A key and a value, in each key value pair, indicate the category of the system entity and the system entity respectively. The pre-defined condition represents a relation between the key and the value. Subsequently, a query may be generated based on the key-value pair corresponding to each system entity. In one embodiment, a context associated to the textual interaction may be derived based on a pre-defined set of rules. The context may be derived based on a context building mechanism having a dynamic analytics template library comprising the textual interaction, enterprise data and corpus data stored in the data repository, role of the user, context of the conversation, context of the user's previous conversation. In one aspect, the context facilitates to enrich the query executed to extract the data, from the data repository, relevant to the context of the textual interaction.

Based on the context and the query, the data may be extracted from the data repository. In one aspect, the data extracted from the data repository may be stored in a cache memory of the system. It may be noted that the cache memory facilitates to retrieve extraction of the data faster than the direct extraction of the data from the data repository as it facilitates the system to avoid searching the data in the data repository and thereby helps in improving the processing speed of the system. Subsequent to the extraction of the data, the data may be visualized in a graphical form using one or more predefined visualization templates. While aspects of described system and method for visualizing the data in the graphical form and may be implemented in any number of different computing systems, environments, and/or configurations, the embodiments are described in the context of the following exemplary system.

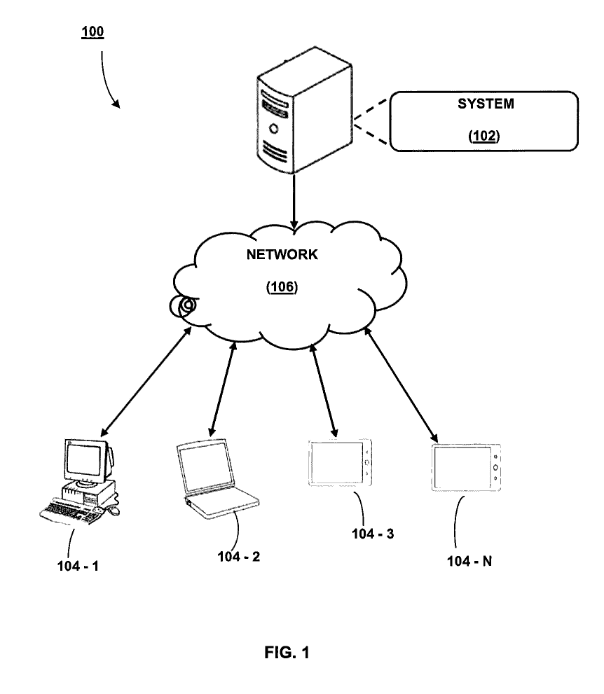

Referring now to FIG. 1, a network implementation 100 of a system 102 for visualizing data in a graphical form based on information exchanged between pluralities of users on a social-networking platform is disclosed. In order to visualize the data, initially, the system 102 captures textual interaction amongst a plurality of users on a social-networking platform. Upon capturing the textual interaction, the system 102 pre-processes the textual interaction in order to identify one or more business entities associated to the textual interaction. In one aspect, each business entity may be identified corresponding to a category of a plurality of predefined categories. Subsequent to the identification of the one or more business entities, the system 102 further identifies a system entity corresponding to each business entity based on a pre-defined mapping of a plurality of business entities with a plurality of system entities stored in a data repository. Subsequently, the system 102 generates a key-value pair having a pre-defined condition corresponding to each system entity. A key and a value, in each key value pair, indicate the category of a system entity and the system entity respectively. The pre-defined condition represents a relation between the key and the value. Further, the system 102 generates a query based on the key-value pair corresponding to each system entity. The system 102 further derives a context associated to the textual interaction based upon a predefined set of rules. Based on the query and the context, the system 102 extracts data from the data repository. Subsequent to the extraction of the data, the system 102 visualizes the data in a graphical form using one or more predefined visualization templates.

Although the present disclosure is explained considering that the system 102 is implemented on a server, it may be understood that the system 102 may also be implemented in a variety of computing systems, such as a laptop computer, a mobile communication device (Smartphone), a desktop computer, a notebook, a workstation, a mainframe computer, a server, a network server, a cloud-based computing environment. It will be understood that the system 102 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the Internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

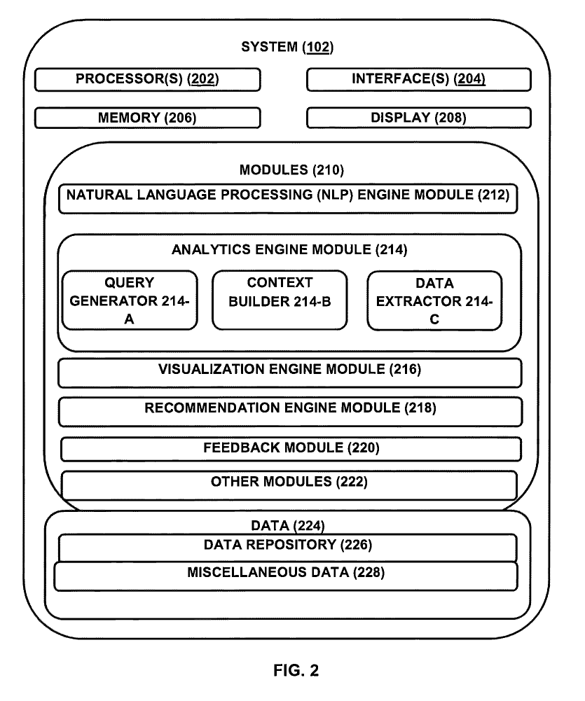

Referring now to FIG. 2, the system 102 is illustrated in accordance with an embodiment of the present subject matter. In one embodiment, the system 102 may include at least one processor 202, an input/output (I/O) interface 204, a memory 206, and a display 208. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions or modules stored in the memory 206.

The I/O interface 204 may include a variety of software and hardware interfaces, for example, a web interface, a graphical user interface, and the like. The I/O interface 204 may allow the system 102 to interact with a user. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium and computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 210 and data 224.

The modules 210 include routines, programs, objects, components, data structures, etc., which perform particular tasks or implement particular abstract data types. In one implementation, the modules 210 may include a Natural Language Processing (NLP) Engine module 212, an analytics engine module 214, a visualization engine module 216, a recommendation engine module 218, a feedback module 220, and other modules 222. The analytics engine module 214 may further include a query generator 214-A, a context builder 214-B, and a data extractor 214-C. The modules 208 described herein may be implemented as software modules that may be executed in the cloud-based computing environment of the system 102. The other modules 222 may include programs or coded instructions that supplement applications and functions of the system 102. Each of the modules is explained in detail in subsequent paragraphs of the specification.

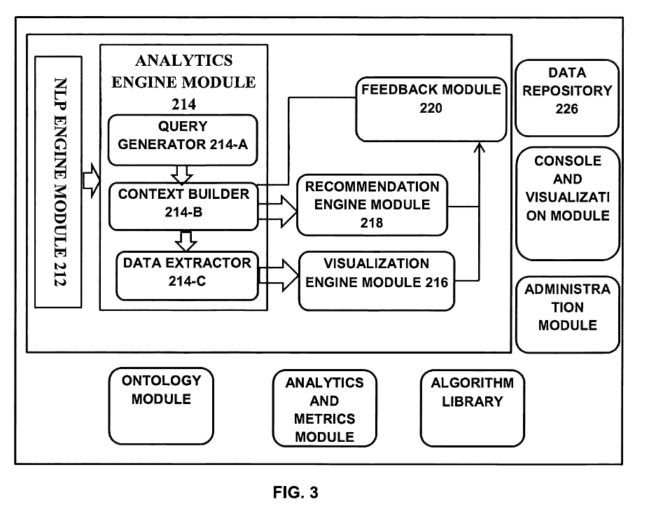

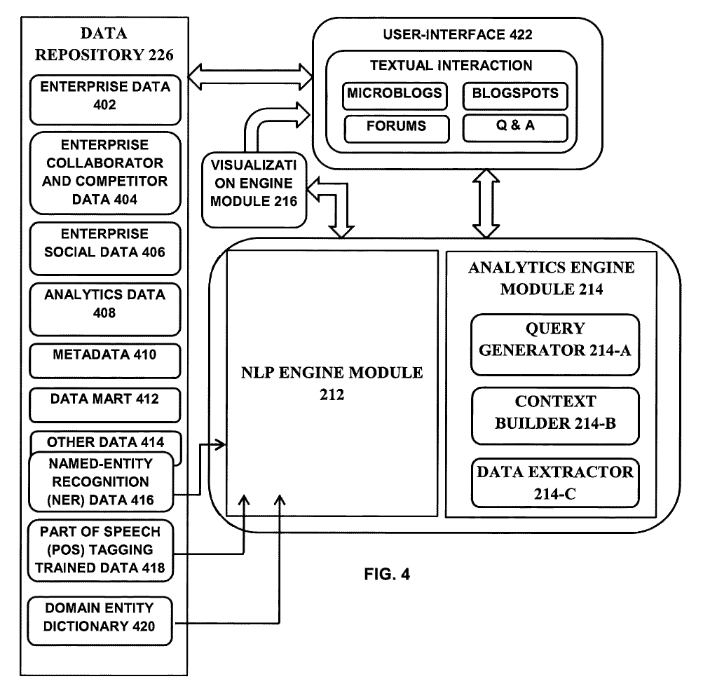

The data 224, amongst other things, serves as a repository for storing data processed, received, and generated by one or more of the modules 210. The data 224 may also include a data repository 226 and miscellaneous data 228. The miscellaneous data 228 may include data generated as a result of the execution of one or more modules in the other modules 222.The detailed description of the modules 210 along with other components of the system 102 is further explained referring to FIGS. 3 and 4.

According to embodiments of present disclosure, the data repository 226 as illustrated in FIGS. 3 and 4 corresponds to large storage repository that holds the data related to an enterprise, and may also include the following type of data:

Enterprise data 402—The data related to the enterprise's products, services, stakeholders (such as employees, customers, vendors, banks and the like), and other data related to the enterprise for different geographies (locations), markets (B2B, B2C), time periods, seasons, weather-based, technologies, infrastructure, Human Resource (HR).

Enterprise Collaborator data and Competitor data 404—Publicly available data related to the enterprise collaborators and competitors also referred to as collaboration data. In one aspect, the Collaborator data further comprises textual interaction between the stakeholders of the enterprise on the social-networking platform. The stakeholders may include, but not limited to, employees, clients/customers, dealers/vendors, and the like. Further, the textual interaction identified from email servers may also be referred to as the collaboration data.

Enterprise Social data 406—Data derived from the social networking sites such as Facebook™, Twitter™, Linkedin™, Yammer™ and other social enterprise platforms.

Analytics data 408—Analyzed data regarding the enterprise obtained from the system and other sources or stakeholders.

Metadata 410—Data associated with the enterprise and enterprise related products or services and the like.

Data Mart 412—Structured data, extracted from the data store, based on the users' requirements and stored in a cache memory for fast retrieval of data.

Other data 414—Data excluding the above.

The data repository 226 further comprises crowd sourcing data obtained from the social-networking platforms. In one aspect, the crowd sourcing data may also be leveraged while generating the information as requested by the user. In addition to the above, the data repository 226 may further comprise the corpus-related data including, but not limited to, Data dictionaries, NER Dictionary, Domain-Entity Dictionary, Ontology, Thesaurus, and POS mapping trained data. However, it is to be noted that the aforementioned data are mere elucidations of the present subject matter and do not restrict the scope of the invention.

It may be understood that day-to-day affairs of the enterprise may broadly be captured as textual interaction between a pluralities of stakeholders within the enterprise. Though the textual interaction is in an unstructured format but when transformed into a structured format, the textual interaction may facilitate the enterprise to derive data insights. In one aspect, the unstructured format indicates that the textual interaction generally involves use of colloquial language which is not interpreted by the system, therefore the textual interaction must be transformed into the structured format in order to make the system 102 understand the context of the textual interaction and facilitates the user to derive the data insights. The data insights may further assist management of the enterprise to make operational changes in the enterprise that are beneficial for the enterprise. Thus, in order to make such operational changes, it becomes necessary to transform the textual interaction into machine understandable format for visualizing data in a graphical form thereby deriving the data insights.

Now referring to FIGS. 3 and 4, in order to visualize the data, initially, the NLP engine module 212 captures the textual interaction from a user-interface 422 of the social-networking platform for further processing. The social-networking platform may include, but not limited to, microblogs, blogposts, forums, comments, and Questions and Answers. It may be understood that the textual interaction captured from the social-networking platform is in the form of natural language text. The textual interaction may comprise at least one of transaction data, reference data and metadata. It may be understood that the transaction data refers to the textual interaction regarding any transaction within the enterprise. For example, email conversation between employees ‘Emp₁’ and ‘Emp₂’ of an enterprise ‘E₁’ regarding data migration from ‘Server A’ to ‘Server B’ since Mar. 1, 2015 is the transaction data. The reference data, on the other hand, refers to the reference terms frequently used in the enterprise, generally for indexing purposes. For example, ‘INDIA’ is being referred to as ‘IND’, ‘Males’ are referred to as ‘M’, and ‘Females’ are referred to as ‘F’. The metadata refers to the data associated with the transaction data and the reference data. For example, pattern validation of a phone number.

In one aspect, when the textual interaction is captured from microblogs, blogposts, or forums, a microblog ID, a blogpost ID, and a forum ID is generated respectively corresponding to the textual interaction captured from the respective social-networking platforms, as shown in the FIG. 4. Similarly, when a user poses a direct query on the social-networking platform, a Q&A ID is generated. It may be understood that the textual interaction and data pertaining to Q&A data may be stored as the collaboration data in the data repository 226.

In order to elucidate further consider an example where a User ‘U₁’ publishes a Post ‘P₁’ on a social-networking platform,

‘P₁’—‘Generate a bar graph depicting the topline growth for XYZ Textiles for the past three quarters’.

In the above Post ‘P₁’, ‘topline growth’ refers to ‘net profits’ of the enterprise. Similarly, ‘quarter’ refers to ‘period of 3 months’ in a financial year. While it is easier for a person to decode such terminologies, it may not possible for the system 102 to interpret the intent of the User ‘U₁’ behind the Post ‘P₁’.

Upon capturing the textual interaction, the NLP engine module 212 pre-processes the textual interaction in order to identify one or more business associated with the textual interaction. It may be understood that each business entity of the one or more business entities is a real-world entity. Example of an business entity may include, but not limited to name of persons, organizations, locations, expressions of times, quantities, monetary values, percentages, product, brand, sales target, revenue, net profit, operational cost, financial year, quarter.

In order to identify the one or more business entities, the NLP engine module 212 pre-processes the textual interaction. The pre-processing further comprises parsing the textual interaction in order to convert natural language text to functional language. The textual interaction may be converted based on data cleansing, Named Entity Recognition (NER) and POS Tagging.

In one embodiment, the data cleansing includes cleansing the textual interaction as free-form natural language text. In one aspect, the data cleansing may be performed by sentence splitting, sentence segmentation, sentence boundary detection, word boundary detection, tokenization, removing abbreviations, converting n-grams to unigrams (identifying Bi-grams or higher as a single entity, and converting to unigrams), convert text to lower case and lemmatize, and convert numbers to text.

The Named Entity Recognition (NER), on the other hand, includes locating and classifying each business entity present in the textual interaction into at least one pre-defined category. In one embodiment, each business entity may be identified corresponding to a category of a plurality of predefined categories. The plurality of predefined categories may include, but not limited to, duration, stakeholder, parameter, and geography. In order to classify the each business entity into the at least one pre-defined category, a Named Entity Recognition (NER) Library may be used which is based on a columnar database, for example, HBase, wherein the data is stored as a key-value (k, v) pair to extract the business entity from the textual interaction. Further, the NER library may be evolutionary wherein the matching may be performed by a statistical NER approach (by using generative or discriminative algorithm, depending on the Enterprise's requirements).

In order to elucidate aforementioned functionality of the NLP engine module 212, consider an example (1), where multi-user (U₁, U₂ and U₃) textual interaction takes place, such that U₁ is the Branch manager, U₂ and U₃ are the chief Managers of ‘ABC Bank’. The textual interaction between U₁, U₂ and U₃ are as follows:
1. U₁: ‘RBI hikes repo rate in January 2015’.
2. U₂: ‘How is the quarterly performance of ABC Bank?’
3. U₃: ‘Do you mean the impact of hike on the interest margins of ABC Bank in India?’

Based on the above, the NLP engine module 212 identifies business entities preset in the textual interaction. It may be understood that the business entities identified are ‘January 2015’, ‘ABC Bank’, ‘Interest margins’, ‘India’, and ‘quarterly’. Upon identification of the business entities, the NLP engine module 212 further classifies each business entity into a category of the plurality of predefined categories. The classification of each business entity into the category is shown in the table 1 as below:

| Category | Business Entity | Users |
|---|---|---|
| Duration | January 2015 | U1 |
| Stakeholder | ABC Bank | U2 |
| Parameter | Interest Margins | U3 |
| Geography | India | U3 |
| Duration | Quarterly | U2 |

In one embodiment, the NLP engine module 212 further performs contextual highlighting by color-coding to each category that are being identified corresponding to each business entity, and further displaying it to the user during the textual interaction. In an example, three users (U₁, U₂, and U3) interacting on the social-networking platform. The contextual highlighting is performed by color-coding each category, identified corresponding to each business entity present in the in the below textual interaction, may be determined as:
1. U₁: RBI hikes repo rate in ‘January 2014’ (Color: Red).
2. U₂: How is the quarterly (Color: Red) performance of ‘ABC Bank’ (Color: Blue)?
3. U₃: Do you mean the impact of hike on the ‘interest margins’ (Color: Green) of ‘ABC Bank’ (Color: Blue) in ‘India’ (Color: Yellow)?

In the above example the business entities are identified corresponding to a category of a plurality of predefined categories based on the contextual highlighting i.e. color: ‘Red’ corresponds to ‘duration’, color: ‘Blue’ corresponds to ‘stakeholder’, color: ‘Green’ corresponds to ‘parameter’ and color: ‘Yellow’ corresponds to ‘geography’ as listed above. In one aspect, the context highlighting may vary depending on the enterprise's requirements.

Subsequent to the identification of the one or more business entities, each business entity is being further represented as a system entity. This is because since each business entity identified in the textual interaction is free-form natural language text, therefore each business entity is represented as the system entity so that the system 102 understands the context of the textual interaction from the free-form natural language text. In order represent each business entity as the system entity; the NLP engine module 212 may further identify a system entity corresponding to each business entity based on a pre-defined mapping of a plurality of business entities with a plurality of system entities stored in the data repository 226. In one embodiment, the pre-defined mapping of the plurality of business entities and the plurality of system entities is stored based on Domain Entity Dictionary and external metadata pertaining to the textual interaction. For example, when the terminology used by stakeholders in the textual interaction such as ‘topline growth’, the NLP engine module 212 refers to the pre-defined mapping and identifies ‘net profits’ as the system entity corresponding to the ‘topline growth’. Thus, in this manner, the NLP engine module 212 facilitates to identify the system entity corresponding to each business entity identified in the textual interaction.

In one example, the pre-defined mapping of each business entity, present in the textual interaction between the multi-users (U₁, U₂ and U₃) as described in example (1) and the table 1, with the system entity is shown in table 2 as below:

| Category | Business Entity | System Entity |
|---|---|---|
| Duration | January 2015 | 01-01-2015 to 31-01-2015 |
| Stakeholder | ABC Bank | ABC Bank |
| Parameter | Interest Margins | Net Interest Income |
| Geography | India | India |
| Duration | Quarterly | Month (sysdate-(sysdate-90)) |

In one embodiment, if the system entity is not identified based on the pre-defined mapping of the plurality of business entities with the plurality of system entities, the NLP engine module 212 determines the system entity based on the external metadata injected into the system 102 and thereby updates the data repository 226 accordingly for future reference.

In addition to the above, the NLP engine module 212 further performs POS Tagging. The POS tagging comprises assigning a part of speech (POS) to an element or a word in a text, indicating the grammatical function such as noun, verb, adjective, etc. In one implementation, the industry standard POS Tagger may be incorporated to perform efficient POS Tagging. The POS Tagging enables the system 102 to syntactically analyze the textual interaction. For example, consider a user poses a query, mentioned below

“What is the Cost of funds of ABC Bank in India in January 2015?”

The NLP engine module 212 perform the POS tagging on the query shown in the figure (c) i.e.:

‘What/WP is/VBZ the/DT cost/NNS of/IN funds/NNP of/IN ABC/NNP Bank/NNS in/IN India/NNP in/IN January/CD 2015/CD’

Subsequent to the identification of the system entity, the analytics engine module 214 analyzes the one or more system entities identified in the textual interaction. It may be understood that the analytics engine module 214 further comprises a query generator 214-A, a context builder 214-B, and a data extractor 214-C. The query generator 214-A generates a key-value pair having a pre-defined condition corresponding to each system entity. A key and a value, in each key value pair, indicate the category of the system entity and the system entity respectively. In one aspect, the pre-defined condition represents a relation between the key and the value. The query generator 214-A further generates a query based on the key-value pair corresponding to each system entity. For example, if the user publishes a post P₁ on a social-networking platform:

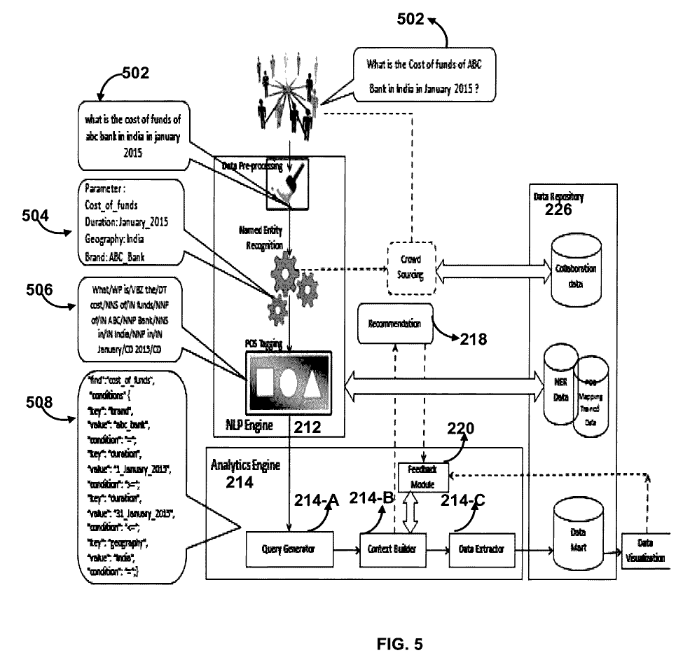

Post P₁: ‘What is the Cost of funds of ABC Bank in India in January 2015? as shown in block 502 of FIG. 5.

As shown in the block 504 of FIG. 5, the NLP engine module 212 pre-processes the textual interaction to identify the business entities in the textual interaction as ‘january_2015’, ‘India’, and ‘abc_bank’. The NLP engine module 212 further performs the POS tagging on the textual interaction as shown in block 506. The query generator 214-A then generates the key-value pair having a pre-defined condition corresponding to each system entity as shown below and also in block 508 of FIG. 5.

“find”:“cost_of_funds”,
“conditions” {
“key”: “product”,
“value”: “abc_bank”,
“condition”: “=”;
“key”: “duration”,
“value”: “1_January_2015”,
“condition”: “>=”;
“key”: “duration”,
“value”: “31_January_2015”,
“condition”: “<=”;
“key”: “geography”,
“value”: “India”,
“condition”: “=”;}

The query generator 214-A further generates a query based on the key-value pair corresponding to each system entity. Further, it may be noted that such query generation is dynamic, and may be implemented for most of the textual interaction.

Further referring to FIGS. 3, 4, and 5, the context builder 214-B, present within the analytics engine module 214, analyzes the textual interaction in order to derive the context of the textual interaction. In one embodiment, the context may be derived based on a pre-defined set of rules. The pre-defined set of rules may include, but not limited to, role of the user, context of the conversation, and context of the users' previous conversation. Based on the context, the context builder 214-B facilitates to extract the data, for efficient content delivery to the user, from the data mart 412 stored in the data repository 226.

In one embodiment, the context builder 214-B performs two tasks. Firstly, the context builder 214-B utilizes a dynamic analytics template to interpret the information that the user may be interested in, and triggers the data extractor 214-C to extract the data from the data repository 226 based on the on the query and the context. In one implementation, the dynamic analytics template may be static or pre-defined. In another implementation, the context builder 214-B may use machine learning algorithms to generate dynamic templates that may further act as a training set for new template creation. Secondly, the context builder 214-B interprets the various possible recommendations, based on the textual interaction and presents it to the user.

It may be understood that for determining the context, it becomes necessary for the context builder 214-B to have a pre-defined threshold dimensions. In view of the above, the context builder 214-B may be configured in a manner such that the context builder 214-B verifies one or more categories are greater than the pre-defined threshold categories. It may be understood that the pre-defined threshold categories are required for interpreting the context and thereby deriving the data insights for the textual interaction correctly. In some cases, the pre-defined threshold categories may be set to default, as per the enterprise's requirements. In one aspect, the system 102 has a provision to dynamically change or update the pre-defined threshold dimensions. For example, in case where a user published a Post P₁,

Post P₁: “What is the sales volume in 2015”?

It may be understood that ‘product’ and ‘geography’ categories are not mentioned in the above post P₁. Since the pre-defined threshold categories are not available in the post P₁, the context builder 214-B may extract huge data, which may be absurd and therefore it becomes difficult for the context builder 214-B to derive the context. Therefore, in this case, the ‘product’ and the ‘geography’ categories need to be mentioned in the textual interaction before the context builder 214-B may begin generation of the required information. The context builder 214-B may further be configured to select relevant templates based on the one or more categories identified for analytics purposes. The context builder 214-B may further be configured to identify all possible information that may be derived based on the context of the textual interaction. Before the user explicitly asks for a query, the context builder 214-B triggers the data extractor 214-C to extract the data from the data repository 226, and store the required information to a cache memory. This reduces the processing time involved in the extraction of the data from the data repository 226. The data extracted may further be used while generating recommendations to the user. In one aspect, the recommendations may be generated based on a ranking algorithm, identifying top-n recommendations most relevant to the user based on the context of the textual interaction.

In order to elucidate the aforementioned description, consider a Use-Case where three users (U₁, U₂, and U₃) are collaborating on a social-networking platform. The textual interaction between U₁, U₂, and U₃ is mentioned below:

U₁: RBI hikes repo rate in January 2014.

U₂: What is the impact on the performance of ABC Bank?

U₃: Do you mean the impact on cost of funds of ABC Bank in India?

Upon receiving the textual interaction, the context builder 214-B performs analytics on the textual interaction, based on the dynamic analytics template, to identify the following effects:

1) Increase in cost of funds

2) Decrease in net interest margin

3) Discounts offered on car loans and home loans to decrease the cost of funds

Based on the analytics, the data extractor 214-C associated with the analytics engine module 214 extracts the data from the data repository 226 and inserts in the cache memory, which may further be used for generation of requisite information. Such data extraction is further based on authorization of a particular user to access such data. It may be understood that the data extracted may be represented to the user by the visualization engine module 216 in a graphical form using one or more predefined visualization templates. For example, the data may be represented in form of bar-graph, or pie-chart. In one embodiment, the visualization engine module 216 facilitates to represent the data, extracted by the data extractor 214-C, in a visualization template having the predefined format pre-selected by the user. In one aspect the visualization template may be customized based on the requirement of the user. It may be understood that the visualization engine module 216 may comprise a machine learning algorithm and tools to dynamically generate visual templates. The visualization engine module 216 may further comprise a view builder that facilitates customized viewing, depending on the role of the user or the stakeholder. For example, a CEO of an organization would like a holistic and summarized view of reports, whereas a sales manager would be concerned about the reports pertaining to his work location, and branches/offices in his vicinity. In view of the above, the view builder triggers the visualization engine module 216 to represent the data depending upon the role of the user (i.e. CEO or sales manager).

In one embodiment, the recommendation engine module 218 generates “dynamic” recommendations as suggested by the context builder 214-B. As illustrated in the Use-Case, as aforementioned, following are the possible recommendations generated by the recommendation engine module 218 for the textual interaction corresponding to the three users (U₁, U₂, and U₃):

1) Change in NIM in this quarter, compared to previous quarter.

2) Deposits—CASA ratio comparison for the past 4 quarters

3) Loans and advances comparison of ABC Bank for Q4FY15 and Q3FY15.

4) Contact our Expert “Mr. XYZ” to know more

It may be understood from the aforementioned Use-Case that the recommendation engine module 218 may further provide the links to generate the data for the first three recommendations. The fourth recommendation, on the other hand, is an example of a strategy finder concept. The strategy finder concept enables the recommendation engine module 218 to generate recommendation based on the data obtained from the dynamic analytics template, and hence, enables the user of the system 102 to devise strategy based on the pro-actively generated recommendation set. In the above mentioned example, the system 102 may identify the possible consequences/analytics on the user interaction data. Based on that, the recommendation engine module 218 may infer that ‘Mr. XYZ is an expert in a specific domain’, and the textual interaction, of the users', with the expert in the domain may facilitate the user to derive further inferences, while considering the context of the textual interaction. In order to elucidate further, consider an example where the expert advises a user that car loan interest rates may reduce due to the hike in repo rates. The user may then devise a strategy based on the advice provided to him by the expert. Thus, the system 102 may facilitate the user to identify/devise the most relevant and appropriate strategy in this case, and highlighted the same to the user. Such customized recommendations may be generated by the combination of the various evolutionary and dynamic template libraries thereof.

Subsequent to the generation of the recommendation, the feedback module 220 captures the input from the user whether the recommendations have been useful for the user or not. This self-learning mechanism enables the system 102 to improve the quality of information life cycle management. For example, considering a scenario where the user requests for sales report of ‘ABC’ Company in Asia for last quarter. The system 102 generates a bar chart comparing sales with respect to time. However, the user requires a pie chart comparing sales with respect to geography (country wise division of sales volume). This feedback of the user may be captured by the system 102, and the revised output may be generated accordingly. Similarly, the users may suggest if the recommendation provided by the recommendation engine module 218 is based on the context of the textual interaction or not. Thus, in this manner, the feedback module 220 influences the context capture and content delivery performed by the context builder 214-B.

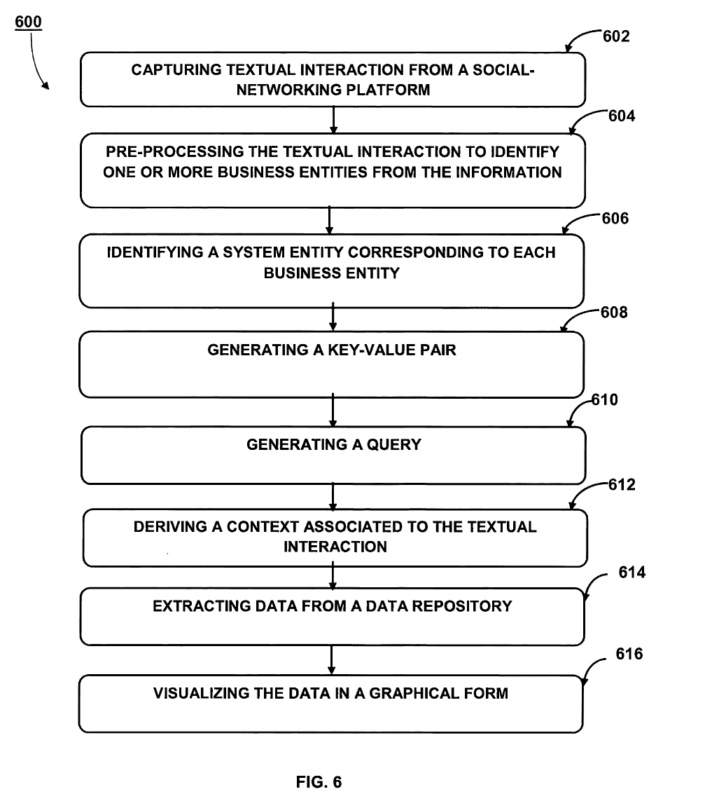

Referring now to FIG. 6, a method 600 for visualizing data in a graphical form based on information exchanged between pluralities of users on a social-networking platform is shown, in accordance with an embodiment of the present disclosure. The method 600 may be described in the general context of computer executable instructions. Generally, computer executable instructions can include routines, programs, objects, components, data structures, procedures, modules, functions, etc., that perform particular functions or implement particular abstract data types. The method 600 may be practiced in a distributed computing environment where functions are performed by remote processing devices that are linked through a communications network. In a distributed computing environment, computer executable instructions may be located in both local and remote computer storage media, including memory storage devices.

The order in which the method 600 is described is not intended to be construed as a limitation, and any number of the described method blocks can be combined in any order to implement the method 600 or alternate methods. Additionally, individual blocks may be deleted from the method 600 without departing from the spirit and scope of the disclosure described herein. Furthermore, the method can be implemented in any suitable hardware, software, firmware, or combination thereof. However, for ease of explanation, in the embodiments described below, the method 600 may be considered to be implemented in the above described in the system 102.

At block 602, textual interaction may be captured from a social-networking platform. In one implementation, the textual interaction may be captured by the NLP engine module 212.

At block 604, the textual interaction may be pre-processed in order to identify one or more business entities associated with the textual interaction one. In one aspect, each business entity may be identified corresponding to a category of a plurality of predefined categories. In one implementation, the textual interaction may be pre-processed by the NLP engine module 212.

At block 606, a system entity may be identified corresponding to each business entity based on a pre-defined mapping of a plurality of business entities with a plurality of system entities stored in a data repository 226. In one implementation, the system entity may be identified by the query generator 214-A.

At block 608, a key-value pair having a pre-defined condition corresponding to each system entity may be generated. In one aspect, a key and a value, in each key value pair, indicate the category of a system entity and the system entity respectively. The pre-defined condition represents a relation between the key and the value. In one implementation, the key-value pair may be generated by the query generator 214-A.

At block 610, a query may be generated based on the key-value pair corresponding to each system entity. In one implementation, the query may be generated by the query generator 214-A.

At block 612, a context associated to the textual interaction may be derived based upon a predefined set of rules. In one implementation, the context may be derived by the context builder 214-B.

At block 614, data may be extracted from the data repository 226 based on the context and the query. In one implementation, the data may be extracted by the data extractor 214-C.

At block 616, the data may be visualized in a graphical form using one or more predefined visualization templates. In one implementation, the data may be visualized by the visualization engine module 216.

Exemplary embodiments discussed above may provide certain advantages. Though not required to practice aspects of the disclosure, these advantages may include those provided by the following features.

Some embodiments enable a system and method to analyze the discussion based on customizable and dynamic dimensions, and generate graphical representation of such data, so that the user may leverage the information given by the system for drawing inferences on the discussed subject matter.

Some embodiments enable a system and method to provide recommendations based on the data obtained from the dynamic analytics template, and hence, enables the user of the system to devise strategy based on the pro-actively generated recommendation set.

Although implementations for methods and system for providing data insights to a user based on information exchanged between pluralities of users on a social-networking platform have been described in language specific to structural features and/or methods, it is to be understood that present disclosure is not necessarily limited to the specific features or methods described. Rather, the specific features and methods are disclosed as examples and may provide certain advantages. Though not required to practice aspects of the disclosure, these advantages may include those provided by the following features.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A processor-implemented method for visualizing data in a graphical form based on information exchanged between a plurality of users on a social-networking platform, the method comprising:
capturing, by a processor, textual interaction amongst a plurality of users on a social-networking platform;
pre-processing, by the processor, the textual interaction in order to identify one or more business entities associated with the textual interaction, wherein each business entity is identified corresponding to a category of a plurality of predefined categories;
identifying, by the processor, a system entity corresponding to each business entity based on a pre-defined mapping of a plurality of business entities with a plurality of system entities stored in a data repository;
generating, by the processor, a key-value pair having a pre-defined condition corresponding to each system entity, wherein a key and a value, in each key value pair, indicates the category of a system entity and the system entity respectively, and wherein the pre-defined condition represents a relation between the key and the value;
generating, by the processor, a query based on the key-value pair corresponding to each system entity;
deriving, by the processor, a context associated to the textual interaction based upon a predefined set of rules;
extracting, by the processor, data from the data repository based on the query and the context; and
visualizing, by the processor, the data in a graphical form using one or more predefined visualization templates.

2. The method of claim 1 further comprising
determining the system entity based on external metadata; and
updating the data repository,
when the system entity is not identified based on the predefined mapping of the plurality of business entities with the plurality of system entities.

3. The method of claim 1, wherein the textual interaction is captured from at least one of the social-networking platform comprising a Blog, a forum, a Question and Answer collaboration platform, and an electronic mail.

4. The method of claim 1, wherein the one or more business entities comprise product, brand, sales target, revenue, net profit, operational cost, financial year, quarter.

5. The method of claim 1, wherein the system entity is further identified based on at least one of data dictionary, NER dictionary, domain-entity dictionary, ontology, thesaurus, and POS mapping trained data, and wherein the system entity is stored in the data repository.

6. The method of claim 1, wherein the plurality of predefined categories comprise duration, stakeholder, parameter, and geography.

7. A system for visualizing data in a graphical form based on information exchanged between a plurality of users on a social-networking platform, the system comprising:
a processor; and
a memory, coupled to the processor, wherein the processor is capable of executing a plurality of modules stored in the memory, and wherein the plurality of modules comprising:
a Natural Language Processing (NLP) engine module for
capturing textual interaction amongst a plurality of users on a social-networking platform,
pre-processing the textual interaction in order to identify one or more business entities associated with the textual interaction, wherein each business entity is identified corresponding to a category of a plurality of predefined categories, and
identifying a system entity corresponding to each business entity based on a pre-defined mapping of a plurality of business entities with a plurality of system entities stored in a data repository;
a query generator for
generating a key-value pair having a pre-defined condition corresponding to each system entity, wherein a key and a value, in each key value pair, indicates the category of a system entity and the system entity respectively, and wherein the pre-defined condition represents a relation between the key and the value, and
generating a query based on the key-value pair corresponding to each system entity;
a context builder for deriving a context associated to the textual interaction based upon a predefined set of rules;
a data extractor for extracting data from the data repository based on the query and the context; and
a visualization engine module for visualizing the data in a graphical form using one or more predefined visualization templates.

8. The system of claim 7, wherein the system entity is further identified based on at least one of data dictionary, NER dictionary, domain-entity dictionary, ontology, thesaurus, and POS mapping trained data.

9. The system of claim 7, wherein the plurality of predefined categories comprise duration, stakeholder, parameter, and geography.

10. The system of claim 7 further comprising a recommendation engine module for dynamically generating at least one recommendation based on the context of the data derived by the context builder.

11. The system of claim 7 further comprising a feedback module facilitating the user to input feedback related to the at least one recommendation.

12. A non-transitory computer readable medium embodying a program executable in a computing device for visualizing data in a graphical form based on information exchanged between a plurality of users on a social-networking platform, the program comprising a program code:
a program code for capturing textual interaction amongst a plurality of users on a social-networking platform;
a program code for pre-processing the textual interaction in order to identify one or more business entities associated with the textual interaction, wherein each business entity is identified corresponding to a category of a plurality of predefined categories;
a program code for identifying a system entity corresponding to each business entity based on a pre-defined mapping of a plurality of business entities with a plurality of system entities stored in a data repository;
a program code for generating a key-value pair having a pre-defined condition corresponding to each system entity, wherein a key and a value, in each key value pair, indicates the category of a system entity and the system entity respectively, and wherein the pre-defined condition represents a relation between the key and the value;
a program code for generating a query based on the key-value pair corresponding to each system entity;
a program code for deriving a context associated to the textual interaction based upon a predefined set of rules
a program code for extracting data from the data repository based on the query and the context; and
a program code for visualizing the data in a graphical form using one or more predefined visualization templates.
